(19) United States
(12) Patent Application Publication
(10) Pub. No.: US 2022/0398445 A1
(43) Pub. Date: Dec. 15, 2022

(54) IDENTIFYING A CLASSIFICATION HIERARCHY USING A TRAINED MACHINE LEARNING PIPELINE

(71) Applicant: Oracle International Corporation, Redwood Shores, CA (US)

(72) Inventors: Alberto Polleri, London (GB); Rajiv Kumar, Austin, TX (US); Marc Michiel Bron, London (GB); Guodong Chen, Austin, TX (US); Shekhar Agrawal, Austin, TX (US); Richard Steven Buchheim, Almeda, CA (US)

(73) Assignee: Oracle International Corporation, Redwood Shores, CA (US)

(21) Appl. No.: 17/303,918

(22) Filed: Jun. 10, 2021

(51) Int. Cl. G06N 3/08; G06K 9/62

(52) U.S. Cl. CPC G06N 3/08; G06K 9/6268; G06K 9/6202; G06K 9/6219; G06K 9/6215; G06K 9/6262

(57) ABSTRACT

Techniques are disclosed for using a trained machine learning (ML) pipeline to identify categories associated with target data items even though the identified categories may not already be present in the hierarchy. The ML pipeline may include trained cluster-based and classification-based machine learning models, among others. If the results of the cluster-based and classification-based machine learning models are the same, then the target data items is assigned to a hierarchical classification consistent with the identical results of the machine learning model. An assigned hierarchical classification may be validated by the operation of subsequent trained ML models that determine whether parent and child categories in the identified classification are properly associated with one another.

### TECHNICAL FIELD

The present disclosure relates to hierarchical classification of data. In particular, the present disclosure relates to identifying a classification hierarchy in data using a trained machine learning pipeline.

### BACKGROUND

Descriptions and terminology used in any of a variety of contexts change over time. Also, at any one time, terminology may often differ between different organizations (“entities”) even when referring to the same subject matter. The natural variation in terminology when describing the same subject matter, whether between entities or over time, complicate analysis of data items because the meaning of terminology may be uncertain. Alternatively, a query for subject matter using a first term may fail to identify a query result that refers to the target subject matter but is described using a second, different, term.

Applying consistent terminology to a field of subject matter would improve analytical efficiency and accuracy.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for converting inconsistent or non-standard terminology to a consistent terminology in accordance with one or more embodiments;

FIG. 3 illustrates an example set of operations for identifying categories in a target data set in accordance with one or more embodiments;

FIG. 4 illustrates an example set of operations for validating categories identified in a target data set in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. IDENTIFYING CATEGORIES USING AN ML PIPELINE

4. VALIDATING CATEGORIES

5. EXAMPLE EMBODIMENT

6. COMPUTER NETWORKS AND CLOUD NETWORKS

7. MISCELLANEOUS; EXTENSIONS

8. HARDWARE OVERVIEW

### 1. General Overview

One or more embodiments apply multiple independently trained and executed machine learning models for assigning a hierarchical classification to a target data item. The system applies both a cluster-based machine learning model and a classification-based machine learning model to determine candidate hierarchical classifications for a target data item. If both candidate hierarchical classifications are identical, then the system assigns the candidate hierarchical classification to the target data item. Some embodiments include additional models, each of which may also contribute an independently derived hierarchical classification to the analysis. In these embodiments, if a majority of models agree (e.g., 2 out of 3; 3 out of 4), then the hierarchical classification on which the majority of models agree is associated with a target data item. In some examples, if none of the models agree, then a hierarchical classification of an accurate presumed to be the most accurate is associated with a target data item.

One or more embodiments described in this Specification and/or recited in the claims may not be included in this General Overview section.

### 2. Architectural Overview

Embodiments of a system described below are configured to extract categories and/or a hierarchical set of categories (or “hierarchy” for brevity) from target data items using one or more trained machine learning models. In some cases, the system may identify elements of a hierarchy, such as categories at any level of the hierarchy (e.g., parent (“second level”) categories, child (“first level”) categories) not previously identified. At a high level, the system may accomplish these goals using a sequence of machine learning models, each of which is specifically trained to execute a particular analysis. The individual trained machine learning models are arranged as a “pipeline” so that some of the individual trained machine learning models further process an analytical product output of a preceding machine learning model in the pipeline. In some aspects, results from different trained ML models are compared and a result extracted based on the comparison.

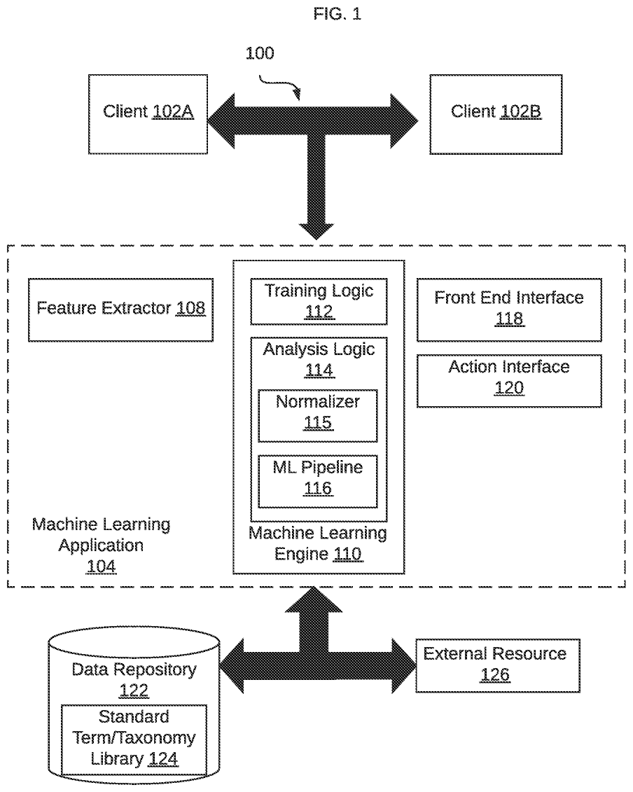

FIG. 1 illustrates a system 100 in accordance with one or more embodiments. As illustrated in FIG. 1, system 100 includes clients 102A, 102B, a machine learning application 104, a data repository 122, and external resource 126. In one or more embodiments, the system 100 may include more or fewer components than the components illustrated in FIG. 1.

The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The clients 102A, 102B may be a web browser, a mobile application, or other software application communicatively coupled to a network (e.g., via a computing device). The clients 102A, 102B may interact with other elements of the system 100 directly or via cloud services using one or more communication protocols, such as HTTP and/or other communication protocols of the Internet Protocol (IP) suite.

In some examples, one or more of the clients 102A, 102B are configured to receive and/or generate data items. The clients 102A, 102B may transmit the data items to the ML application 104 for analysis. The ML application 104 may analyze the transmitted data items by applying one or more trained ML models to the transmitted data items, thereby extracting a hierarchy from the data items.

The clients 102A, 102B may also include a user device configured to render a graphic user interface (GUI) generated by the ML application 104. The GUI may present an interface by which a user triggers execution of computing transactions, thereby generating data items. In some examples, the GUI may include features that enable a user to view training data, classify training data, instruct the ML application 104 to extract a hierarchy from a set of data items, and other features of embodiments described herein. Furthermore, the clients 102A, 102B may be configured to enable a user to provide user feedback via a GUI regarding the accuracy of the ML application 104 analysis. That is, a user may label, using a GUI, an analysis generated by the ML application 104 as accurate or not accurate, thereby further revising or validating training data. In some examples, a user may label, using the GUI, a machine learning analysis of target data generated by the ML application 104, thereby revising aspects of a hierarchy extracted from a set of data items. This latter feature enables a user to label target data analyzed by the ML application 104 so that the ML application 104 may update its training.

The ML application 104 of the system 100 may be configured to train one or more ML models using training data, prepare target data before ML analysis, and analyze target data so as to extract a hierarchy from the prepared target data. As described herein, the ML application 104 may not only extract a hierarchy from target data but even identify categories and/or any hierarchical level of sub-category not previously associated with a category.

The machine learning application 104 includes a feature extractor 108, a machine learning engine 110, a frontend interface 118, and an action interface 120.

The feature extractor 108 may be configured to identify characteristics associated with data items. The feature extractor 108 may generate corresponding feature vectors that represent the identified characteristics. For example, the feature extractor 108 may identify attributes within training data and/or “target” data that a trained ML model is directed to analyze. Once identified, the feature extractor 108 may extract characteristics from one or both of training data and target data.

The feature extractor 108 may tokenize some data item characteristics into tokens. The feature extractor 108 may then generate feature vectors that include a sequence of values, with each value representing a different characteristic token. The feature extractor 108 may use a document-to-vector (colloquially described as “doc-to-vec”) model to tokenize characteristics (e.g., as extracted from human readable text) and generate feature vectors corresponding to one or both of training data and target data. The example of the doc-to-vec model is provided for illustration purposes only. Other types of models may be used for tokenizing characteristics.

The feature extractor 108 may append other features to the generated feature vectors. In one example, a feature vector may be represented as [f₁, f₂, f₃, f₄], where f₁, f₂, f₃ correspond to characteristic tokens and where f₄ is a non-characteristic feature. Example non-characteristic features may include, but are not limited to, a label quantifying a weight (or weights) to assign to one or more characteristics of a set of characteristics described by a feature vector. In some examples, a label may indicate one or more classifications associated with corresponding characteristics.

As described above, the system may use labeled data for training, re-training, and applying its analysis to new (target) data.

The feature extractor 108 may optionally be applied to target data to generate feature vectors from target data. These target data feature vectors may facilitate analysis of the target data by other ML models, as described below.

The machine learning engine 110 of the ML application 104 includes training logic 112 and analysis logic 114. The analysis logic 114 further includes a terminology normalizer 115 and a machine learning pipeline 116.

In some examples, the training logic 112 receives a set of data items as input (i.e., a training corpus or training data set). Examples of data items include, but are not limited to, electronically rendered documents and electronic communications. Examples of electronic communications include but are not limited to email, SMS or MMS text messages, electronically transmitted transactions, electronic communications communicated via social media channels, clickstream data, electronic documents and/or electronically stored text. In one illustration, a type of electronic document may include text files of any format (e.g., .txt, .doc, .PDF) that describe requirements for a job posting, a work history of an applicant, or the like. In some examples, data items may be in the form of structured data (e.g., submitted via a browser form or computing application form (including PDF forms)) or unstructured text (e.g., free text document such as a .txt, .doc. .PDF, or other “blob of text” formats).

In some examples, training data used by the training logic 112 to train the machine learning engine 110 includes feature vectors of data items that are generated by the feature extractor 108, described above.

The training logic 112 may be in communication with a user system, such as clients 102A, 102B. The clients 102A,102B may include an interface used by a user to apply labels to the electronically stored training data set.

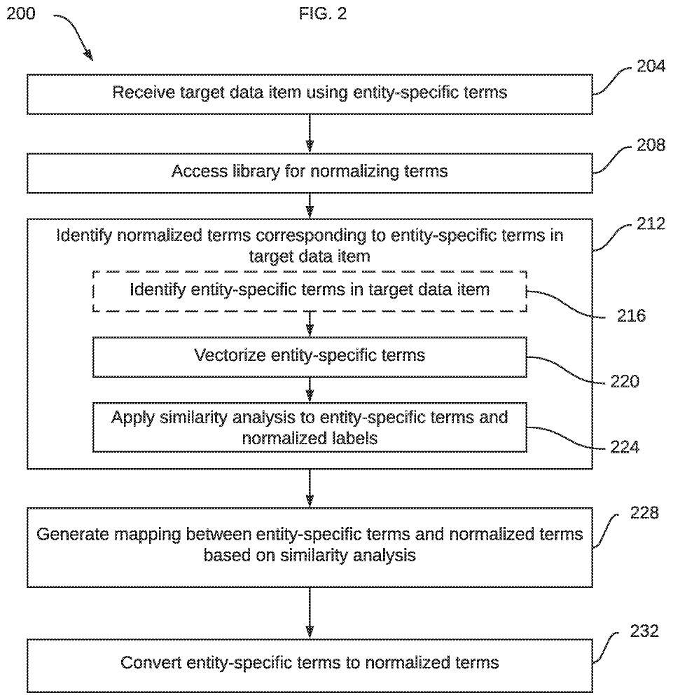

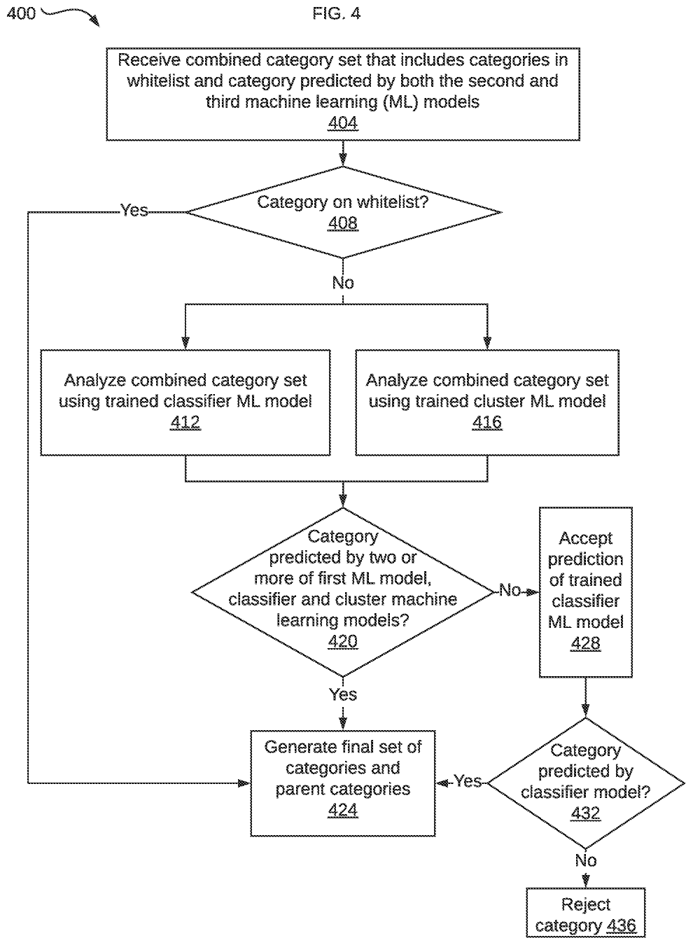

The machine learning (ML) engine 110 is configured to automatically learn, via the training logic 112, a hierarchical classification (sometimes described as an “extracted taxonomy” or “categories”) of data items. The trained ML engine 110 may be applied to target data and analyze one or more characteristics of the target data. These characteristics may be used according to the techniques described below in the context of FIGS. 2, 4 and 4.

Types of ML models that may be associated with one or both of the ML engine 110 and/or the ML application 104 include but are not limited to linear regression, logistic regression, linear discriminant analysis, classification and regression trees, naïve Bayes, k-nearest neighbors, learning vector quantization, support vector machine, bagging and random forest, boosting, backpropagation, neural networks, and/or clustering.

The analysis logic 114 applies the trained machine learning engine 110 to analyze target data. The analysis logic 114 may analyze data items to predict a category of target data items based on one or more attributes associated with the target data items. The analysis logic 114 may use one or more trained ML models to predict a category of a target data item and even predict one or more categories that are not currently present in a hierarchical classification.

The analysis logic 114 is shown in the example illustrated in FIG. 1 as including a normalizer 115 and an ML pipeline 116. Other configurations of analysis logic 114 may include additional elements or fewer elements.

The normalizer 115 functions to relate user-specific terminology to standard terminology, or at least a uniform set of terminology, that is associated with a particular field or particular subject matter. The application of the normalizer 115 to user data improves the accuracy and precision of the results of the system 100 in some embodiments and additionally enables application of the system 100 to any of a variety of industries and even a variety of distinct entities within a particular industry.

The normalizer 115 first receives (e.g., via a user instruction) or independently determines (e.g., via application of a trained ML model) (1) a subject matter or field of interest to the user and (2) identifies a corresponding standardized library of terms related to the indicated field of interest. The normalizer 115 may then create an association or “map” that connects colloquial terms associated with user data with the standardized library. The normalizer 115 may operation on target data, as well as training data, so that data items associated with the user but varying in terminology may be analyzed consistently. For example, an entity may post a job requisition using colloquial terms that are idiosyncratic to the entity, whereas applicants may each use terminology in their applications that are one or both of (a) different from that of the entity and (b) different from one another. The normalizer 115 enables a consistent analysis of these data by finding a common terminology by which to compare job requirements in the requisition and applicant skills.

In some embodiments, the normalizer 115 may include a trained ML model that generates feature vectors from input data items. In the case of text documents, the trained ML model may be a “doc-to-vec” model that generates vectors from text-based electronic documents and/or files. In some examples, commercially available doc-to-vec models that are pre-trained may be employed (e.g., ORACLE® TALEO®).

Once input data items are represented as feature vectors, the normalizer 115 may identify a library of standard terms that corresponds to the subject matter of the data items. For example, the system may execute a comparison using a cosine similarity function between one or more feature vectors corresponding to input data items and portions of standard terminology libraries. For example, the system 100 may be in communication with a data store that includes one or more standard term/standard taxonomy libraries (e.g., library 124 in data repository 122). In some examples, each of these subject matter libraries may have a digest or summary that, when represented as a feature vector, may be efficiently compared by the system to an input data vector to select a most similar library. In one specific illustration, a standard library applicable to human resources applications (talent acquisition, human capital management) is produced by ONET® and may be referred to as the ONET® standard occupational classification (SOC®) system. This particular standard library includes approximately 16000 different job titles. Analogous standard libraries applicable to different subject matter fields exist and may be used depending on the particular application.

Upon identifying a subject matter library that includes standard terms, the system may then “normalize” the terminology in the target data item by identifying terminology in the target data item and then identifying its corresponding standard term. The system may then generate a “normalized” version of the target data item in which colloquial terminology present in the target data item is replaced with a corresponding terms from the standard term library. The details of this normalization process are described below in the context of FIG. 2.

Once the system generates a vector representation of a data item using standard terminology, the analysis logic 114 of the system 100 continues processing the data item via one or more trained machine learning algorithms in the ML pipeline 116.

The ML pipeline 116 may be arranged so that one or more trained machine learning models process an output of a preceding trained machine learning model, thereby subjecting a data item to sequential processing steps. In some examples, the ML pipeline 116 may include multiple trained machine learning models that process a data item or an output of a prior machine learning item either serially, in parallel, or combinations thereof. In some embodiments, described below, a “voting” operation may select between outputs of parallel machine learning model processing that operate on a same version of a data item and may produce different analytical outputs.

In some examples, ML pipeline 116 may include one or both of supervised machine learning algorithms and unsupervised machine learning algorithms. In various examples, these different types of machine learning algorithms may be arranged serially (e.g., one model further processing an output of a preceding model), in parallel (e.g., two or more different models further processing an output of a preceding model), or both. As indicated above, for parallel processing configurations, the ML pipeline 116 may include criteria by which to select between the outputs of parallel branches within the pipeline. In some examples, a selected output of a segment of the ML pipeline 116 may be further processed by additional serial or parallel ML model configurations. In other examples, a selected output of a segment of the ML pipeline 116 may be used to produce an analytical conclusion (e.g., a prediction, a recommendation, a predicted category).

An example method of a method using an ML pipeline to identify additional, previously unidentified, categories within a set of data items is described in the context of FIGS. 2-4.

The frontend interface 118 manages interactions between the clients 102A, 102B and the ML application 104. In one or more embodiments, frontend interface 118 refers to hardware and/or software configured to facilitate communications between a user and the clients 102A, 102B and/or the machine learning application 104. In some embodiments, frontend interface 118 is a presentation tier in a multitier application. Frontend interface 118 may process requests received from clients and translate results from other application tiers into a format that may be understood or processed by the clients.

For example, one or both of the client 102A, 102B may submit requests to the ML application 104 via the frontend interface 118 to perform various functions, such as for labeling training data and/or analyzing target data. In some examples, one or both of the clients 102A, 102B may submit requests to the ML application 104 via the frontend interface 118 to view a graphic user interface related to analysis of a target data item in light of a playlist or playlists. In still further examples, the frontend interface 118 may receive user input that re-orders individual interface elements.

Frontend interface 118 refers to hardware and/or software that may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

In an embodiment, different components of the frontend interface 118 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the frontend interface 118 is specified in one or more other languages, such as Java, C, or C++.

The action interface 120 may include an API, CLI, or other interfaces for invoking functions to execute actions. One or more of these functions may be provided through cloud services or other applications, which may be external to the machine learning application 104. For example, one or more components of machine learning application 104 may invoke an API to access information stored in data repository 122 for use as a training corpus for the machine learning engine 104. It will be appreciated that the actions that are performed may vary from implementation to implementation.

In some embodiments, the machine learning application 104 may access external resources 126, such as cloud services. Example cloud services may include, but are not limited to, social media platforms, email services, short messaging services, enterprise management systems, and other cloud applications. Action interface 120 may serve as an API endpoint for invoking a cloud service. For example, action interface 120 may generate outbound requests that conform to protocols ingestible by external resources.

Additional embodiments and/or examples relating to computer networks are described below in Section 6, titled “Computer Networks and Cloud Networks.”

Action interface 120 may process and translate inbound requests to allow for further processing by other components of the machine learning application 104. The action interface 120 may store, negotiate, and/or otherwise manage authentication information for accessing external resources. Example authentication information may include, but is not limited to, digital certificates, cryptographic keys, usernames, and passwords. Action interface 120 may include authentication information in the requests to invoke functions provided through external resources.

In one or more embodiments, a data repository 122 is any type of storage unit and/or device (e.g., a file system, database, collection of tables, or any other storage mechanism) for storing data. Further, a data repository 122 may include multiple different storage units and/or devices. The multiple different storage units and/or devices may or may not be of the same type or located at the same physical site. Further, a data repository 122 may be implemented or may execute on the same computing system as the ML application 104. Alternatively or additionally, a data repository 122 may be implemented or executed on a computing system separate from the ML application 104. A data repository 122 may be communicatively coupled to the ML application 104 via a direct connection or via a network.

In the embodiment illustrated in FIG. 1, the data repository 122 includes a standard term/taxonomy library 124. As described above, the standard term/taxonomy library 124 enables the system 100 to relate colloquial terms from any source (and even multiple different sources) to a single “standard” term. This “conversion” of diverse colloquial terms to a single term enables the system to directly compare data items regardless of the terms the data items use to describe an aspect that is captured by a corresponding term in the standard term/taxonomy library 124.

Information related to target data items and the training data may be implemented across any of components within the system 100. However, this information may be stored in the data repository 122 for purposes of clarity and explanation.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Identifying Hierarchical Categories Using an ML Pipeline

FIG. 2 illustrates an example set of operations, collectively referred to as a method 200, for preparing data for subsequent hierarchical classification analysis, in accordance with one or more embodiments. The method 200 may optionally be applied to data items to map colloquial or idiosyncratic attributes (e.g., attribute names, attribute values) or other descriptions that are used by a specific entity to equivalent attributes. This conversion of attributes from idiosyncratic attributes to “standard” attribute optionally enables the ML models used in subsequent methods (e.g., the methods 300 and 400) to be trained using larger data sets pooled from other entities or data sources regardless of attribute names used. The larger training data set in turn improves model accuracy. The use of the method 200 also enables more accurate and consistent analysis of target data items.

One or more operations illustrated in FIG. 2 may be modified, rearranged, or omitted all together. Accordingly, the particular sequence of operations illustrated in FIG. 2 should not be construed as limiting the scope of one or more embodiments. While the method 200 is presented in the context of target data items (as a preparatory step to the analytical methods 200 and 300), it will be appreciated that the method 200 may be equivalently applied to training data.

The method 200 may begin by receiving one or more target data items that uses entity-specific terminology (operation 204). Examples of entity-specific terminology include terminology used for data item labels, data item descriptions, attribute names, or attribute values. In other examples, entity-specific terminology may include electronic document content.

In a specific illustration, an organization may generate a job requisition that lists a number of job duties and required skills. The natural language used by the entity to describe the job title, job duties, interactions with other job functions in related departments, minimum required credentials, and required skills may be specific (e.g., idiosyncratic) to that particular entity. Any one or more of the words and phrases used by the entity in the job requisition may differ from those used by other entities and/or from more commonly used terminology (e.g., “industry standard”).

Furthermore, in this example the many applicants responding to the job requisition may each use different terminology. This compounds the challenge of identifying a candidate for the position because the tens, hundreds, or thousands of applicants may correspondingly use tens, hundreds, or thousands of different permutations of terminology, few or none of which may be directly applicable to the terminology used by the entity providing the job requisition. As will be appreciated, in this specific illustration the method 200 can be applied to both the job requisition itself and the application data from the applicants so that all source of data use consistent, and conveniently compared, terminology.

Once a target data item is received, the system may access a library for normalizing terms (operation 208). The library may be a library of industry standard terminology. In some examples, terminology libraries may be published by academic institutions, professional organizations, or industry trade groups. Continuing with the specific illustration of the job requisition introduced in operation 204, public domain job title libraries are produced by various human resource professional groups, academic institutions, and companies.

Regardless of the source or the subject matter, the system may access such a library as a precursor to converting target item content terminology (e.g., free text), attribute names, and/or attribute values associated with target data items to uniform, “normalized” equivalents.

The system may then identify normalized terms (e.g., attribute names, attribute values, content) in a library that correspond to the entity-specific terms used in the target data item (operation 212). In some examples, the library may be represented in feature vector form to facilitate comparison with target data, as described below in the context of operation 224. The operation 212 may, in one example, include three operations.

The system may optionally identify entity-specific terms in the target data item (operation 216). This may be accomplished using a trained ML model to execute a cosine similarity analysis on vector representations of terms and/or attributes in a target data item versus a library term.

The system may generate a feature vector of the target data item (operation 220). In one example, the feature vector may be generated from any of the identified entity-specific terms optionally identified in the operation 216. In another example, the system may generate a feature vector based on individual terms and/or permutations of terms in the target data item. In one example, the system uses a “doc-to-vec” trained machine learning model to generate the feature vectors. In one illustration, the system may use a pre-trained doc-to-vec trained machine learning model, such as “Taleo” ®.

The system may train the doc-to-vec machine learning model using a commercially or publicly available training data set and optionally supplement the training by using training data specific to an entity and/or the subject matter that is ultimately analyzed. For example, the system may train the doc-to-vec using a generic (i.e., non-subject matter specific) training data set and/or a commercially or publicly available training data set that is subject matter specific (e.g., human resources, physical sciences, finance). In one example, to improve accuracy of the model as applied to target data items for a specific entity, a supplemental training data set that is specific to terms used by the entity is used to supplement a generic training data set. In another example, the supplemental training data set may even be specific to a specific subject matter field that is specific to the entity (e.g., terms used by the entity in human resources, finance operations).

In some examples, a data item may be represented as a vector that includes tokens for most words and/or phrases in the target data item or alternatively as a set of vectors, each of which corresponds to words and phrases (e.g., groups of two or more words). In some examples, the phrase vectors and/or tokens may include any number of permutations of the words in the target data item. In some examples, the permutations of words that the systems may be delimited by recognizing parts of speech or formatting that indicate a separation of ideas. For example, transitions such as “and,” “or,” and formatting such as semicolons, periods, and bullets may prevent words separated by these features from being combined into a token or vector. This may in turn reduce the number of comparisons executed by the system, thereby improving analytical efficiency of the system as a whole without removing substantive content. In some examples the system may omit definite articles, indefinite articles, and other parts of speech that may be useful to written or spoken communication but not useful when executing a feature vector analysis, such as the one described above.

The system may compare vector representations of normalized terms in the library and entity-specific terms in the target data item operation 224. The operation 224 may identify entity-specific terms and their corresponding analogs in the library of normalized terms. In some examples, this may be accomplished upon the system applying a cosine similarity analysis. The system may identify terms in the target data and the library as analogous when a value produced by the cosine analysis is above a threshold value (e.g., above 0.5, 0.75, 0.8). In other example, the system may apply a K-nearest neighbors trained machine learning model to identify similar terms. Regardless of the comparison algorithm used, the system may generate a version of the vector(s) representing the data item in which colloquial terminology (words/phrases) is replaced with terminology from the standard term library.

Upon identifying analogous terms between the target data and the library, the system generates a mapping between the entity-specific terms and the normalized terms (operation 228). While the term “mapping” is used, it will be appreciated that this simply refers to a reference or other indication of correspondence between the different, but similar terms.

The system may then apply the mapping to the target data item, thereby converting the entity specific terms to normalized terms (operation 232). The system may generate a version of the feature vector(s) representing the target data item except with feature values corresponding to the normalized terms instead of the entity-specific terms.

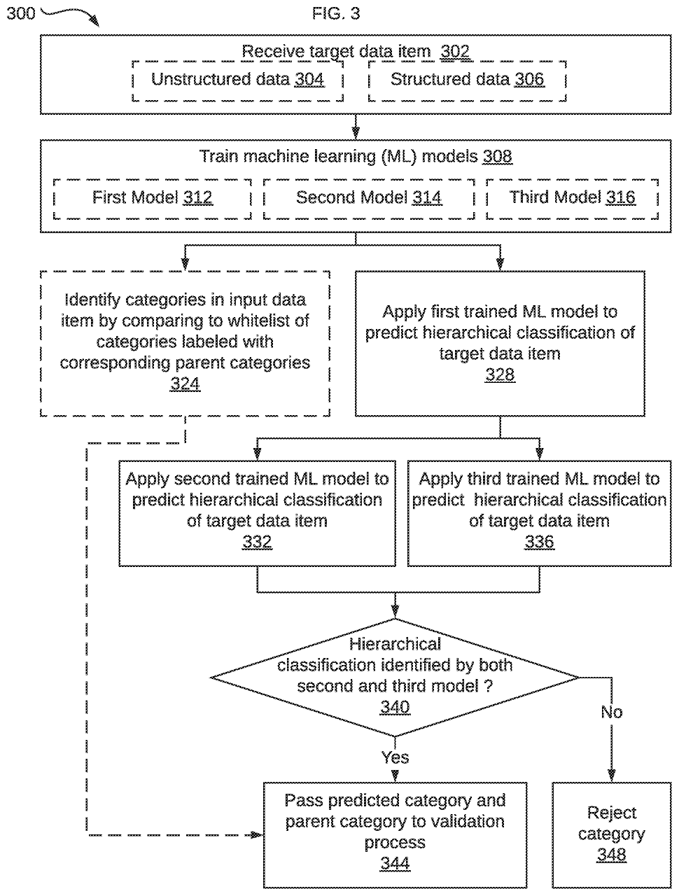

Upon completing the method 200 (which may not be necessary in all situations), the system may then execute a method 300, operations of which are illustrated in FIG. 3. One or more operations illustrated in FIG. 3 may be modified, rearranged, or omitted all together. Accordingly, the particular sequence of operations illustrated in FIG. 3 should not be construed as limiting the scope of one or more embodiments.

Upon application of the method 300, the system may determine or otherwise identify hierarchical categories within one or more (normalized) target data items. In some examples, the system may, with the method 300, identify new hierarchical categories exhibited by one or more target data items even when those categories are not already part of an existing hierarchy. In various examples, application of the method 300 may identify any one or more of a category in any level of a hierarchy whether at a leaf node level (i.e., a “first” level), a direct parent level to the leaf node level (i.e., a “second” level “above” (i.e., more general than) the first level), or even higher levels.

The method 300 includes receiving a target data item for analysis (operation 302). Examples of target data items include electronic documents in any number of forms. In one illustration of the diversity of data types accommodated by the system, examples of these different forms include unstructured data (operation 304) or structured data (operation 306). Examples of unstructured data 304 include data items that include free text, with few restrictions on the words, values, format, syntax, and/or punctuation permitted. Specific types of free text analyses that the system may employ include a so-called “bag of words” or, when used in the Python programming language, a “blob of words.” The ability of the system to process unstructured text may be particularly useful when, for example, receiving document or data items produced separately from individual sources. Continuing with the job requisition illustration, the system may process unstructured, text-based resumes that describe applicant experiences using not only different terminology but also different formats, different document organization schemes, and the like. As described, these unstructured data items may be submitted via an unstructured web or computing application form, an email, a social media post, an SMS or MMS text message, a text editing document, and the like.

Examples of structured data (operation 306) include data submitted by a structured web or computing application form, a PDF® “fillable” form, and the like. In some examples, the system may identify fields in a structured data item according to a field name and/or structured data item metadata. These identifying features may, individually or separately, instruct the system as to the expected values for each field, the types of ML processing to be applied, and the like.

Regardless of the form in which a target data item is received, the system may process the target data items into a “normalized” form using the method 200. The system may convert the target data item into a vector representation to facilitate additional analysis by the system. The system may execute the normalization conversion process according to the method 200 before, during, or after conversion of the data item into a corresponding feature vector.

The method 300 includes training one or more machine learning (ML) models that the system uses to progressively analyze one or more target data items (operation 308). In the example of FIG. 3, the system employs three machine learning models, although any number of one or more trained machine learning models may be used to process data items according to the present disclosure.

In some examples, the first trained ML model (operation 312) may include a trained machine learning model that is trained to identify categories based on the text of the target data item alone. In some examples, the first trained ML model is configured to identify a broader set of potential categories in a target data item than is present in the narrower, but confirmed accurate, whitelist. The whitelist is described below in the context of the operation 324. In this way, the first trained ML model may detect new categories within one or more target data items that are not present in the whitelist.

In some examples, the first trained ML model may be a “named entity recognizer” or NER trained ML model. In some examples the system executes any type of NER model, one example of which is the Stanford NER model. An NER model analyzes individual words and phrases (i.e., permutations of words) in the document. Based on its training, the NER model may determine whether any of the individual words and/or phrases (or other detectable attributes) are associated with a corresponding category. In some examples, the first trained ML model may be trained using a manually selected and labeled list of categories or manually selected and labeled data items. In other examples, the NER model may be trained using a trained neural network that provides categories and context data to the NER model.

In some examples, the second trained ML model is a classifier model (operation 314). In other examples, the second trained ML model is a neural network or “deep learning” model. In either case, the second trained ML model is trained to identify categories and parent categories associated with data item attributes, individual tokens and/or permutations of tokens (e.g., generated from words/text by a doc-to-vec model) in a target data item. Regardless of the type of model, the second trained ML model analyzes the received output from the first trained ML model and determines, using its own classification analysis, whether the category identified by the first trained ML model is correctly identified.

The second trained ML model may be trained using supervised learning techniques. For example, the second trained ML model may be trained using manually labeled data, such data items in which words and phrases have been indicated as a category by labeling with a parent category. For example, a whitelist (described below) with its identified categories and parent category labels may be used to train the second trained ML model to identify correct associations between data item attributes and categories. Similarly, attributes used to generate the whitelist but that are not associated with a category may be labeled to indicate the lack of a category association with those attributes. This provides negative training examples to the second ML model. In other examples, analogous to those described above, the second trained ML model may be trained using a neural network trained to identify categories.

In some examples, the third trained ML model (operation 316) is an unsupervised machine learning model, such as a clustering model. In one embodiment, the third trained ML model may be a K-means clustering model. In one embodiment the third trained ML model may be trained using the whitelist (described below). The third trained ML model may use the whitelist data to generate clusters of vectors representing the known correct categories. In other embodiments, the third trained ML model may use unlabeled training data to generate a plurality of clusters representing categories. In some examples, the third trained ML model may use any one or more of a cosine similarity, K-means, or K-nearest neighbor algorithm to identify clusters within training data.

Prior to application of any of the trained ML models, the system identifies categories associated with a target data item by referring to a “whitelist” of known correct categories and their associated attributes (operation 324). The whitelist may include a list of vectors representing categories known to be valid. In some examples, the whitelist may also include associated attributes (e.g., words/phrases, other attributes, and/or tokens thereof). However, as appreciated in light of the present disclosure, a whitelist may not include all correct categories actually present in one or more data items. The following operations of the method 300 (and the method 400) are configured to identify additional categories present in the data and that are not reflected on the whitelist. Furthermore, the method 300 (and the method 400) also include operations that preserve the integrity of the identified categories by reducing the likelihood that an erroneous or incorrect category is predicted from the data.

In some examples, the whitelist of categories may be specific to an entity or subject matter field. In some examples, the whitelist may be generated by trained machine learning model analysis (e.g., doc-to-vec, neural network), prepared manually, or accessed from a third party entity (e.g., an industry trade group, professional organization, academic institution, corporate entity). As indicated above, the whitelist includes categories know to be correct which may improperly exclude categories that should be on the whitelist.

In one example, a whitelist may be generated by analyzing a data set of data items and labeling each category within each data item of the data set. In some examples, the category labels are binary indicating whether an attribute value (or a feature vector token) is a category or not a category. As indicated above, in one example category labels may be applied to individual tokens and/or individual feature vectors representing corresponding permutations of words and/or attributes in a data item.

In other examples, the category labels are not binary, but instead label the identified category with an associated, more general, parent (or second level) category. Labeling child (equivalently leaf or first) level categories identified in a data item that are to be included on the whitelist with a corresponding second level category has the benefit of associating hierarchy information with an identified first level category via the label itself. This process may be repeated for every first level category identified in a training document. This is distinct from labeling a training document as a whole with a single label. The identified first level categories and their labels are extracted from training data and compiled to collectively form the whitelist.

For example, continuing with the job requisition illustration, an identified first level category may be identified as a job skill of “hiring manager.” Examples of training documents used to identify first and corresponding second level categories may include a reference document used by the entity (e.g., commercially available or provided by an industry trade group), a set of resumes used for machine learning training purposes, an entity-specific or set of job skill listings, and the like. The label associated with the first level category (job skill) may indicate a second level category of “Human Resources Operations” (organization function). This association of “hiring manager” with “Human Resources Operations” in the data label provides hierarchy information to the system. Furthermore, a training document (e.g., a resume, job requirements list) may include many skills, each of which is labeled. For example, the same training document that includes proficiency in various computer programs may be identified as a first level category and labeled with a corresponding second level category (“Computer Skills”). Similarly, the same training document may include accounting, which the system identifies as a first level category and labels with a corresponding second level category (“Finance Operations”).

The system may apply the first trained machine learning model as part of the process for predicting a hierarchical classification for a target data item (operation 328). In one example, the first trained ML model may identify categories by associating attributes such as words, phrases, and/or permutations of words (or more precisely, their corresponding feature vectors/tokens) in the target data item with a category. These attributes and their permutations are analyzed to determine whether the attributes and/or permutations are associated with a category.

In some examples, NER model output is an identified category, its associated parent category label, and a portion of data item context in which the category is identified. By detecting candidate categories and passing the categories and the context of the data item in which a candidate category is detected to subsequent models may improve the overall accuracy of subsequent analyses.

The approach using the first trained ML model, in particular an NER model, may cause the first trained ML model to generate “false positive” category identifications. That is, the first trained ML model may incorrectly identify aspects in one or more data items as categories but that are not categories. The improper identification of categories is operationally problematic as it generates an incorrect hierarchical classification. Once an error is introduced into a hierarchical classification, the errors may expand over time as more data items are analyzed. This in turn may cause a time consuming manual correction. To prevent or reduce a likelihood that the system identifies incorrect categories, the analytical output of the first trained ML model may be subsequently processed to remove these “false positive” categories by the collective operation of the second trained ML model and the third ML trained model. These operations are described below.

The second trained ML model (operation 314) and the third trained ML model (operation 316) may together determine whether a candidate category identified by the first trained ML model is a false positive or is a correct result. The system analyzes the result from the first trained ML model (operation 328) with both of the second and third trained ML models in operations 332 and 336 respectively.

In one example, the system applies the second trained ML model to the output of the first trained ML model, which may include category, parent category label, and corresponding context (operation 332). The system may use the analysis of the second trained ML model to, in part, determine the accuracy of the first ML model.

In some examples, the second trained ML model receives the target data item previously analyzed by the first trained ML model and classifies words and/or phrases (e.g., permutations of words) according to category and parent category. In some examples, the second trained ML model analyzes phrases of words as a way of placing substantive words in context, thereby better determining a meaning and/or importance associated with a particular attribute (e.g., word or phrase). In some examples, the second trained ML model may increase its computational efficiency by omitting certain words and/or parts of speech (e.g., articles, conjunctions, superlatives) that are unlikely to be associated with substantive content, as described above.

In some embodiments, the second trained ML model determines whether a category is properly associated with a parent category based on its training. For example, the second ML model may use its classifier-based algorithm to determine, based on data item attributes, the hierarchical classification of the data item. If the identified category and parent category are consistent with one another, the second trained ML model labels the category and parent with a label indicating that the category is correct (i.e., a “1”). Additionally or alternatively, the second ML model may determine if the hierarchical classification generated by the second ML model is consistent with that generated by the first ML model. This result also generates a label indicating the consistency. If the identified category and parent category are not consistent with one another, or not consistent with the result of the first trained ML model, the second trained ML model labels the category and parent with a label indicating that the category is incorrect (i.e., a “0”).

These analytical results of and the associated category/parent category data may be then passed to a subsequent stage of the ML pipeline for analysis in combination with results of the third trained ML model, described below.

The system may apply the third trained ML model (operation 336). For embodiments in which the third trained ML model is a clustering model, the model may identify a centroid of each cluster and calculate a variability (or noise) value in one or more dimensions defining each cluster. In some embodiments, the model calculates cluster variability using a Silhouette coefficient to quantify a variability value for each cluster.

The third trained ML model may then evaluate output of the first trained ML model by, in some examples, associating a vector representation of a category generated by the first trained ML model to one or more clusters. Once assigned, the third trained ML model calculates a Silhouette coefficient for a cluster with the newly added vector. If the Silhouette coefficient increases upon addition of the output vector of the first trained ML model or otherwise exceeds a threshold value, thereby indicating an increase in cluster variability, the system determines that the output vector should not be associated with that cluster. However, if the Silhouette coefficient decreases upon addition of the output vector of the first trained ML model, or otherwise is below a threshold value, thereby indicating a decrease in cluster variability, the system determines that the output vector is properly associated with that cluster. In this way, the third trained ML model independently determines parent category associations (i.e., a hierarchical classification) for categories identified by the first trained ML model even if the categories are not previously identified categories (e.g., on the whitelist). This process may be iterated for each output vector of the first trained ML model with each cluster.

In other examples, the third trained ML model may execute a cosine similarity analysis to determine whether a newly added vector is properly associated with a vector representing a data items in a cluster. If a cosine value comparing the vectors is above a threshold, then the newly added vector (representing the data item) is properly associated with a cluster. If a cosine value comparing the vectors is below a threshold, then the newly added vector (representing the data item) is not properly associated with a cluster.

The system then determines whether one or more of the categories identified by the first trained ML model and separately analyzed by the second and the third trained ML models are potentially valid categories (operation 340). In one example, the system detects whether any categories and corresponding parent categories identified by the first trained ML model have been predicted by both the second trained ML model and the third trained ML model. An equivalent description of this process is that both the second trained ML model and the third trained ML “vote” on a particular predicted category (and predicted parent category) based on their own respective analyses. In one example, if both the second trained ML model and the third trained ML model have (a) identified the same category and (b) identified the category as properly relevant to an identified parent category (e.g., via a cosine similarity analysis, clustering analysis, neural network analysis or the like), then a category and parent category are identified as potentially valid.

If both the second trained ML model and the third trained ML model predict a particular category and corresponding parent category within a target data item, then the system passes the predictions to the method 400 for validation (operation 344).

In some examples, the whitelist of categories and corresponding parent categories may be combined with the categories and parent categories identified by the second trained ML model and the third trained ML model. This optional combination is indicated in FIG. 3 by a dashed arrow connecting the operation 324 and the operation 344.

However, if a category identified by the first trained ML model is not identified by both of the second trained ML model and the third trained ML, then the category is rejected (operation 348). The rejected category is not passed to the method 400 for validation.

Validating Categories

FIG. 4 illustrates an example set of operations, collectively referred to as a method 400, for validating categories identified in the method 300 in preparation for updating a hierarchy of classifications with newly identified and correct categories, in accordance with one or more embodiments. One or more operations illustrated in FIG. 4 may be modified, rearranged, or omitted all together. Accordingly, the particular sequence of operations illustrated in FIG. 4 should not be construed as limiting the scope of one or more embodiments.

The method 400 may begin by receiving a combined set of categories, as generated upon the conclusion of the method 300 (operation 404). As described above, the combined set of categories may include categories and corresponding parent categories from the whitelist and as identified by both of the second and third trained ML models. The combined set of categories may represent the categories as feature vectors, as described above. In some embodiments, each of the category feature vectors may identify a source (e.g., via a parameter value or label) from which it was generated. These source include the whitelist, the first trained ML model, the second trained ML model or the third trained ML model.

The system determines whether a particular category has originated from the whitelist or through the combined analysis of the second and third trained ML models (operation 408). For example, the system may analyze a feature vector associated with a particular category and identify a parameter value and/or label in the feature vector that indicates a source of the feature vector. If the source of the feature vector is the whitelist of categories, then the process proceeds to the operation 424 in which the system generates a final set of categories and parent categories. The details of the operation 424 are described below in more detail.

If, at the operation 408, the system determines that a source of the category is not on the whitelist, the system then analyzes the category using two trained machine learning models. In some embodiments, one of these models is a classifier-type trained machine learning model and another one of these models is a clustering trained machine learning model.

The trained classifier ML model may be applied to the category to determine whether the category is likely valid (operation 412). In some examples, the classifier model used in the operation 412 may be trained using the whitelist, as described above. In some embodiments, the trained classifier model used in the operation 412 may be a multi-class machine learning model that is capable of identifying categories, parent categories, grandparent categories, and the like. In other examples, the trained classifier ML model may be a trained deep learning (or neural network) machine learning model.

The system may use the operation 412 to determine whether the child and parent categories identified for the data item by the method 300 are properly associated with one another. In some examples this may be described as the child and parent categories being “relevant” to one another. In some examples, the multi-class classifier model may execute a cosine similarity analysis to determine if the parent and child classification have a similarity above a threshold value. If the identified classifications (or categories) are above the threshold value, then the system determines that the parent and child categories are properly associated with one another. If the identified classifications (or categories) are below the threshold value, then the system determines that the parent and child categories are not properly associated with one another.

The system also analyzes received categories using a trained cluster-based ML model (operation 416). The trained cluster-based ML model may, in some embodiments, be a re-application of the third trained machine learning model 316. In some embodiments, the trained cluster-based ML model may simply execute an analysis analogous to the one described above in the context of the operation 336. That is, the trained cluster-based ML model may cluster the categories received in the operation 404 using a K-means clustering algorithm. The system may provisionally include a newly identified category in a cluster and generate Silhouette coefficients of the cluster that quantify a measure of variability or dispersion of the cluster before and after inclusion of the newly identified category. As described above, if the Silhouette coefficient of a cluster increases (or is above a threshold), representing more variability within the cluster upon addition of the newly identified category, then the category is rejected from that cluster. That is, the parent and child categories identified by the method 300 as hierarchically classified together are not properly associated with one another. If the Silhouette coefficient of a cluster decreases or remains the same (or is otherwise below a threshold value), representing less or equivalent variability within the cluster upon addition of the newly identified category, then the category is associated with that cluster. In other words, the parent and child categories are properly hierarchically related to one another. This process may be repeated for each cluster and each newly identified category until each newly identified category is assigned to a cluster or rejected by the trained cluster-based ML model.

The method 400 then proceeds to the operation 420 where the collected analytical results of three machine learning models are analyzed in a “voting” process to determine whether or not to include an identified category in a hierarchy. This may equivalently be referred to as “validating” a category.

The analytical results of the three machine learning models that are analyzed are the first trained ML model 312, described in the operation 328, and the trained ML models described in operations 412 and 416. A category is validated by determining whether any two of these three trained ML models have identified a particular category (optionally in association with a parent category).

If any two of these trained ML models have produced a same prediction in the operation 420, then the category is validated (operation 424). In some examples, the system may append the newly validated category to the whitelist, thereby expanding the list of known correct categories.

If none of the three models are consistent with one another in the prediction of a particular category (i.e., a category is predicted by only one of the three models), then the system may resolve this conflict by accepting the prediction of the classifier ML model applied in the operation 412 (operation 428). The system may select the prediction of the classifier ML model based on a presumption that the classifier ML model is the most accurate of the three models that are executing this voting process in the operation 420.

In the operation 432, the system determines whether the disputed category has been predicted by the classifier model in the operation 412. If the disputed category has been predicted by the classifier model, then the category is included in a final set of categories according to the operation 424. If the disputed category has not been predicted by the classifier model but instead been predicted by one of the other two models, then the category is rejected (operation 436).

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

In one embodiment, the systems above may be applied to human capital management, such as talent acquisition. As described above, a job position by an entity may result in receiving multiple applicant resumes. The system may execute the terminology “normalizing” operation so that the system may execute subsequent operations on vector representations of resume content that uses consistent terminology.

The system may compare vector representations of words and/or phrases in the received resumes to a whitelist of skills and associated business functions. The skills in this example correspond to the child categories and the associated business functions correspond to the parent categories. Illustrations of job skills and corresponding business functions may include, respectively: heating system maintenance and facilities management; accounting and financial operations; Java programming and engineering; employee supervision and management.

Once any whitelisted skills and business functions are identified, the system applies a named entity recognizer trained ML model to broadly identify candidate skills and associated business functions. As described above, the system executes the named entity recognizer trained ML model to identify any potential skills and corresponding business functions not on the whitelist. For example, the system may determine two illustrations of skills and business functions not on the whitelist: (1) loan administration/financial operations; and (2) oil rig operation/business operations. In these illustrations, the identified first hierarchy not on the whitelist is a proper association between skill and business function and the identified second hierarchy is not a proper association.

The system then applies a classification-based trained ML model and a cluster-based trained ML model to the first and second identified hierarchies. In one illustration, the classification-based trained ML model identifies both of the identified hierarchies as proper, and the cluster-based trained ML model correctly identifies the first hierarchy as proper and the second hierarchy as improper. Because the two models agree on the first identified hierarchy and not on the second identified hierarchy, only the first identified hierarchy is passed to subsequent operations in an ML pipeline for validation. The second identified hierarchy is rejected.

The first identified hierarchy of “loan administration/financial operations” is analyzed using another trained multi-class classifier-based ML model and the clustering-based ML model described above. Both of these models execute their analyses, and both determine that the association is proper. Furthermore, the named entity recognizer, having initially generated the first identified hierarchy, also concurs with this analysis. As described above, only two of the three ML models need to concur at this stage of processing to validate the hierarchy.

In some examples, validation of the hierarchy by the other trained multi-class classifier-based ML model and the clustering-based ML model association may be based on independent predictions executed by both models or may be determined based on a similarity analysis and/or Silhouette coefficient analysis to assure that the job skill and business function are sufficiently similar to one another to warrant validation. Once validated, the first identified hierarchy of “loan administration/financial operations” may be added to the whitelist for future use.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

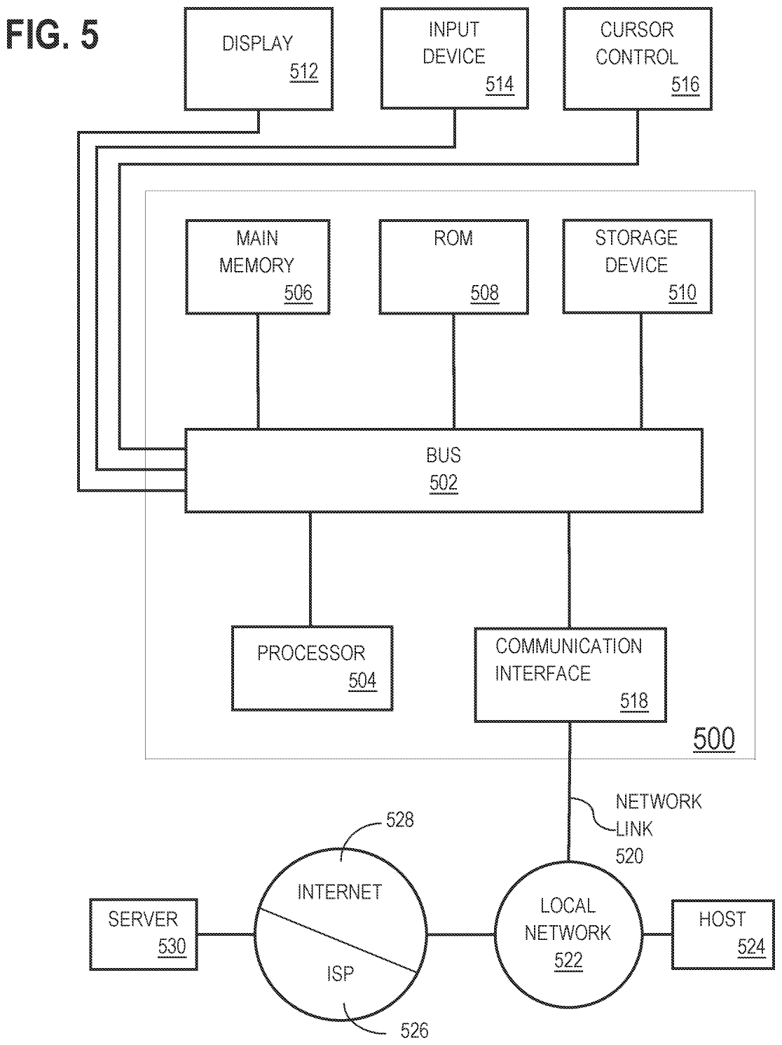

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
training a cluster-based machine learning model and a classification-based machine learning model to associate data items with corresponding categories in a hierarchical set of categories;
receiving a first target data item to be categorized into a corresponding first category in a first level of the hierarchical set of categories;
applying the cluster-based machine learning model to the first target data item to generate a first hierarchical classification, wherein applying the cluster-based machine learning model comprises:
identifying a first candidate cluster, of a plurality of clusters, for the first target data item, the first candidate cluster corresponding to the first hierarchical classification, the plurality of clusters being determined by the cluster-based machine learning model based on a first set of training data;
comparing (1) a first variance value of the first candidate cluster with the target data item to (2) a second variance value of the first candidate cluster without the target data item to compute a difference value;
responsive to determining that the difference value is less than a threshold difference value: identifying the first hierarchical classification, corresponding to the first candidate cluster, as a first candidate classification for the first target data item;
applying the classification-based machine learning model to the first target data item to generate a second hierarchical classification, wherein applying the classification-based machine learning model comprises:
analyzing attributes, corresponding to the first target data item, to identify the second hierarchical classification as a second candidate classification for the first target data item;
responsive at least to determining that the first hierarchical classification determined by the cluster-based machine learning model and the second hierarchical classification determined by the classification-based machine learning model are identical: assigning one of the first hierarchical classification or the second hierarchical classification to the first target data item as the first category in the first level of the hierarchical set of categories.

2. The media of claim 1, wherein identify the first candidate cluster is based on attributes of first target data item.

3. The media of claim 1, wherein the classification-based machine learning model comprises a neural network, and analyzing the attributes corresponding to the first target data item comprises applying the neural network to the attributes of corresponding to the first target data item.

4. The media of claim 1, further comprising:
applying the cluster-based machine learning model to a second target data item to generate a third hierarchical classification;
applying the classification-based machine learning model to the second target data item to generate a fourth hierarchical classification; and
responsive at least to determining that the third hierarchical classification determined by the cluster-based machine learning model and the fourth hierarchical classification determined by the classification-based machine learning model are different: not assigning one of the third hierarchical classification or the fourth hierarchical classification to the second target data item as a second category in the first level of the hierarchical set of categories.

5. The media of claim 1, further comprising validating the first hierarchical classification or the second hierarchical classification assigned to the first target data item at least by:
applying an additional trained cluster-based machine learning model to determine a first similarity value between a first level category and a second level category associated with the assigned first hierarchical classification or the assigned second hierarchical classification;
applying a trained multi-class classification-based machine learning model to determine a second similarity value between the first level category and the second level category associated with the assigned first hierarchical classification or the assigned second hierarchical classification; and
responsive to determining that the first similarity value and the second similarity value are both above a threshold value, validating the first hierarchical classification or the second hierarchical classification assigned to the first target data item.

6. The media of claim 1, wherein the first target data item comprises one or more of a resume, a job profile, or a job requisition, and wherein the first category comprises an applicant skill.

7. The media of claim 1, wherein the first hierarchical classification and the second hierarchical classification are generated independently.

8. A method comprising:
training a cluster-based machine learning model and a classification-based machine learning model to associate data items with corresponding categories in a hierarchical set of categories;
receiving a first target data item to be categorized into a corresponding first category in a first level of the hierarchical set of categories;
applying the cluster-based machine learning model to the first target data item to generate a first hierarchical classification, wherein applying the cluster-based machine learning model comprises:
identifying a first candidate cluster, of a plurality of clusters, for the first target data item, the first candidate cluster corresponding to the first hierarchical classification, the plurality of clusters being determined by the cluster-based machine learning model based on a first set of training data;
comparing (1) a first variance value of the first candidate cluster with the target data item to (2) a second variance value of the first candidate cluster without the target data item to compute a difference value;
responsive to determining that the difference value is less than a threshold difference value: identifying the first hierarchical classification, corresponding to the first candidate cluster, as a first candidate classification for the first target data item;
applying the classification-based machine learning model to the first target data item to generate a second hierarchical classification, wherein applying the classification-based machine learning model comprises:
analyzing attributes, corresponding to the first target data item, to identify the second hierarchical classification as a second candidate classification for the first target data item;
responsive at least to determining that the first hierarchical classification determined by the cluster-based machine learning model and the second hierarchical classification determined by the classification-based machine learning model are identical: assigning one of the first hierarchical classification or the second hierarchical classification to the first target data item as the first category in the first level of the hierarchical set of categories.

9. The method of claim 8, wherein identify the first candidate cluster is based on attributes of first target data item.

10. The method of claim 8, wherein the classification-based machine learning model comprises a neural network, and analyzing the attributes corresponding to the first target data item comprises applying the neural network to the attributes of corresponding to the first target data item.

11. The method of claim 8, further comprising:
applying the cluster-based machine learning model to a second target data item to generate a third hierarchical classification;
applying the classification-based machine learning model to the second target data item to generate a fourth hierarchical classification; and
responsive at least to determining that the third hierarchical classification determined by the cluster-based machine learning model and the fourth hierarchical classification determined by the classification-based machine learning model are different: not assigning one of the third hierarchical classification or the fourth hierarchical classification to the second target data item as a second category in the first level of the hierarchical set of categories.

12. The method of claim 8, further comprising validating the first hierarchical classification or the second hierarchical classification assigned to the first target data item at least by:
applying an additional trained cluster-based machine learning model to determine a first similarity value between a first level category and a second level category associated with the assigned first hierarchical classification or the assigned second hierarchical classification;
applying a trained multi-class classification-based machine learning model to determine a second similarity value between the first level category and the second level category associated with the assigned first hierarchical classification or the assigned second hierarchical classification; and
responsive to determining that the first similarity value and the second similarity value are both above a threshold value, validating the first hierarchical classification or the second hierarchical classification assigned to the first target data item.

13. The method of claim 8, wherein the first target data item comprises one or more of a resume, a job profile, or a job requisition, and wherein the first category comprises an applicant skill.

14. The media of claim 8, wherein the first hierarchical classification and the second hierarchical classification are independently determined.

15. A system comprising:
at least one device including a hardware processor;
the system being configured to perform operations comprising:
training a cluster-based machine learning model and a classification-based machine learning model to associate data items with corresponding categories in a hierarchical set of categories;
receiving a first target data item to be categorized into a corresponding first category in a first level of the hierarchical set of categories;
applying the cluster-based machine learning model to the first target data item to generate a first hierarchical classification, wherein applying the cluster-based machine learning model comprises:
identifying a first candidate cluster, of a plurality of clusters, for the first target data item, the first candidate cluster corresponding to the first hierarchical classification, the plurality of clusters being determined by the cluster-based machine learning model based on a first set of training data;
comparing (1) a first variance value of the first candidate cluster with the target data item to (2) a second variance value of the first candidate cluster without the target data item to compute a difference value;
responsive to determining that the difference value is less than a threshold difference value: identifying the first hierarchical classification, corresponding to the first candidate cluster, as a first candidate classification for the first target data item;
applying the classification-based machine learning model to the first target data item to generate a second hierarchical classification, wherein applying the classification-based machine learning model comprises:
analyzing attributes, corresponding to the first target data item, to identify the second hierarchical classification as a second candidate classification for the first target data item;
responsive at least to determining that the first hierarchical classification determined by the cluster-based machine learning model and the second hierarchical classification determined by the classification-based machine learning model are identical: assigning one of the first hierarchical classification or the second hierarchical classification to the first target data item as the first category in the first level of the hierarchical set of categories.

16. The system of claim 15, wherein identify the first candidate cluster is based on attributes of first target data item.

17. The system of claim 15, wherein the classification-based machine learning model comprises a neural network, and analyzing the attributes corresponding to the first target data item comprises applying the neural network to the attributes of corresponding to the first target data item.

18. The system of claim 15, further comprising:
applying the cluster-based machine learning model to a second target data item to generate a third hierarchical classification;
applying the classification-based machine learning model to the second target data item to generate a fourth hierarchical classification; and
responsive at least to determining that the third hierarchical classification determined by the cluster-based machine learning model and the fourth hierarchical classification determined by the classification-based machine learning model are different: not assigning one of the third hierarchical classification or the fourth hierarchical classification to the second target data item as a second category in the first level of the hierarchical set of categories.

19. The system of claim 15, further comprising validating the first hierarchical classification or the second hierarchical classification assigned to the first target data item at least by:
applying an additional trained cluster-based machine learning model to determine a first similarity value between a first level category and a second level category associated with the assigned first hierarchical classification or the assigned second hierarchical classification;
applying a trained multi-class classification-based machine learning model to determine a second similarity value between the first level category and the second level category associated with the assigned first hierarchical classification or the assigned second hierarchical classification; and
responsive to determining that the first similarity value and the second similarity value are both above a threshold value, validating the first hierarchical classification or the second hierarchical classification assigned to the first target data item.

20. The system of claim 15, wherein the first target data item comprises one or more of a resume, a job profile, or a job requisition, and wherein the first category comprises an applicant skill.
